(19) United States
(12) Patent Application Publication
(10) Pub. No.: US 2011/0277278 A1
(43) Pub. Date: Nov. 17, 2011

(54) FASTENER BAND ASSEMBLY FOR OBJECT CARRIED ON MAIN BOARD

(76) Inventor: Wentai LO, Taichung (TW)

(21) Appl. No.: 12/786,084

(22) Filed: May 24, 2010

(30) Foreign Application Priority Data
May 12, 2010 (TW) 099208803

(51) Int. Cl. F16B 2/00

(52) U.S. Cl. 24/302

(57) ABSTRACT

A fastener band assembly is provided for fastening an object carried on a main board received inside an enclosure. The fastener band assembly includes male-structured fastener band and a female-structured fastener band, each having an end forming a ring through which a hole is defined for fixing the bands to the main board with the bolts that fix the main board to the enclosure. The male-structure fastener band has a surface forming a serrated structure. The female-structured fastener band has an end forming a locking structure through which a bore is defined and receives a resilient pawl mounted therein. The serrated structure is receivable in the bore of the locking structure for engagement with the pawl thereby fastening an object, such as an interface card or a heat sink positioned under the fastener bands, to the main board, when the fastener bands are tightly stretched.

### BACKGROUND OF THE INVENTION

1. Field of the Invention

The present invention relates to the field of computer enclosures, and in particular to a fastener band assembly that is for fastening an object carried on a main board inside an enclosure and can be manufactured in a simple manner but provides an excellent effect of fastening, thereby being advantageous in environmental conservation and energy saving.

2. The Related Arts

A computer comprises a main board received and fixed inside an enclosure. To fix the main board, the enclosure forms holes at pre-set locations, while the main board forms holes of the same specification at corresponding positions. Bolts are received through the holes to secure the main board in the enclosed. It is often that the main board carries one or more interface cards and a central processing unit (CPU) to which a heat sink is applied. To improve the performances, the interface card is of a bulky size and great weight and it is often nothing surprising that an interface card weighs one or two kilograms. However, the mating engagement between the interface card and the main board is of a pre-set arrangement. Additional fixing may be obtained through a bolt that fixes a cover strip of the interface card to the enclosure. This arrangement of fixing an interface card secures the interface card at one side only and may not be effectively enough for interface cards having extended lengths. Further, external forces and torques may be induced on the interface card during the shipping and transportation of the enclosure containing the main board and such external forces and torques cause severer effect on interface cards of larger sizes. Thus, it is often found that the interface cards are undesirably damaged or separated from the main board during the course of transportation.

Referring to FIG. 1 of the attached drawings, a conventional enclosure 1 comprises additional means for fixing an interface card, which includes an elongate metal plate 2 extending across all interface cards 3 and fixed to the enclosure 1. Fasteners are provided to fasten the interface cards 3. This arrangement, however, is disadvantageous in environmental conservation and energy saving. Further, the installation cost is high and the use is troublesome. In addition, for any adjustment to be made on the interface cards and/or other components inside the enclosure, the fasteners must be first released and this leads to troubles for subsequent maintenance operations and also causes a waste of material, which is against the current trend of environmental protection.

Thus, it is desired to provide a novel fastening arrangement that overcomes the above discussed problems and this is a major challenge for the related industry.

### SUMMARY OF THE INVENTION

The problem to be addressed by the present invention is that an existing enclosure of an electronic product comprises an arrangement that is composed of an elongate metal plates, which extends across several interface cards and is fixed to the enclosure, and a devoted fastener, which fastens each interface card, which arrangement is disadvantageous in environmental conservation and energy saving, requires high installation cost, is troublesome in use, and requires the fasteners to be released first before adjustment of the interface cards or other components inside the enclosure to be carried out, leading to unnecessary troubles for subsequent maintenance and waste of material and thus adverse to the current trend of environmental protection.

To solve such problems and drawbacks, the present invention provides a fastener band assembly for fastening an object carried on a main board received inside an enclosure of an electronic product. The fastener band assembly comprises a male-structured fastener band and a female-structured fastener band. The male-structure fastener band comprises an elongate flexible band-like body having an end forming a ring through which a hole is defined and a surface forming therein a serrated structure comprising multiple longitudinally lined teeth or a corrugated configuration. The female-structured fastener band comprises an elongate flexible band-like body having an end forming a ring through which a hole is defined and an opposite end forming a locking structure through which a bore is defined and receives a resilient pawl mounted therein. With such an arrangement, the holes of the fastener bands are positionable on the main board in alignment with holes formed in the main board. Bolts that are applied to fix the main board inside an enclosure may thus be also used to secure the fastener bands to the main board. A distal end of the male-structured fastener band may then be inserted through the bore of the locking structure of the female-structured fastener band, whereby the pawl of the locking structure engages the serrated structure and thus secure the male-structured fastener band in position against reverse movement of the male-structured fastener band. The fastener bands thus hold an object, such as an interface card at a top of a central or end portion thereof, or hold a top of a heat sink positioned on for example a central processing unit (CPU). The fastener bands are then tightly stretched to securely fastener the interface card or the heat sink on the main board, whereby the interface card or the heat sink will not get off or separated from the main board due to vibration or shocks caused by shipping or transportation of the electronic product containing the main board. The fastener bands have extremely simple structures but offer excellent effect of fastening so that the present invention is advantageous in terms of environmental conservation and energy saving.

The effectiveness of the present invention as compared to the known technology is as follows. The conventional technology uses an elongate metal plate and devoted fasteners to secure interface cards and this is troublesome in use and expensive is const, making it not complying with the current trend of environmental protection and being troublesome for subsequent maintenance operations. Contrary to the known technology, the present invention provides a fastener band assembly for fastening an object carried on a main board inside an enclosure, wherein the fastener bands are of extremely simple structure and may be fixed by bolts received through existing holes defined in the main board to show excellent effect of fastening for example an interface card or a heat sink and making it completely complying with the current trend of environmental protection and energy saving.

### BRIEF DESCRIPTION OF THE DRAWINGS

The present invention will be apparent to those skilled in the art by reading the following description of a preferred embodiment thereof, with reference to the attached drawings, wherein:

FIG. 1 is a perspective view showing conventional interface card fixing plate in an installed condition;

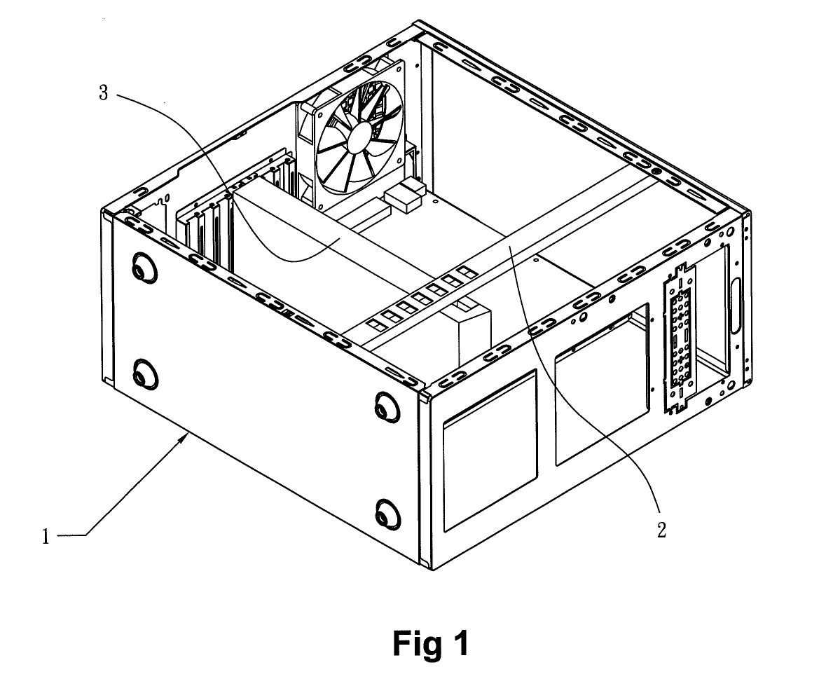

FIG. 2 is a perspective view of a fastener band assembly according to an embodiment of the present invention;

FIG. 3 is a perspective view showing the fastener band assembly of the present invention applied to fasten an interface card to a main board;

FIG. 4 is a perspective view showing the fastener band assembly of the present invention fastening an interface card to a main board received in an enclosure;

FIG. 5 is a perspective view showing the fastener band assembly of the present invention applied to fasten a heat sink to a main board; and

FIG. 6 is a perspective view showing the fastener band assembly of the present invention fastening a heat sink to a main board received in an enclosure.

### DETAILED DESCRIPTION OF THE PREFERRED EMBODIMENT

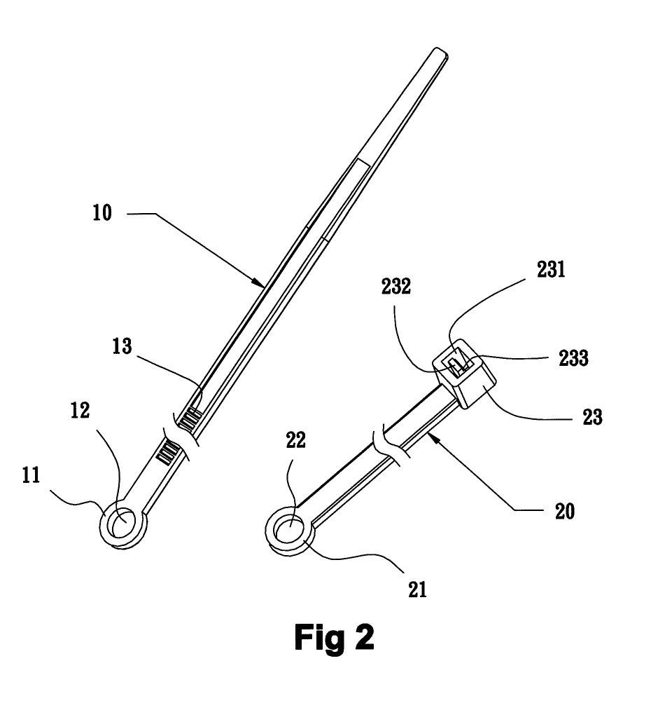

A detailed description of the present invention will be given with reference to the attached drawings, and particularly to FIG. 2, which shows a perspective view of a fastener band assembly according to an embodiment of the present invention. The fastener band assembly is used to securely fasten an object that is mounted to a main board received inside an enclosure of for example an electronic device. The fastener band assembly comprises a male-structured fastener band 10 and a female-structured fastener band 20. The male-structured fastener band 10 has an end forming a ring 11 through which a hole 12 is defined. The male-structured fastener band 10 also comprises an elongate flexible band-like body, preferably made of plastics or the likes. The body of the male-structured fastener band 10 has a surface in which a serrated structure 13, which comprises a plurality of laterally extending teeth, which is spaced in a longitudinal direction, or a corrugated configuration, is formed.

The female-structured fastener band 20 has an end forming a ring 21 through which a hole 22 is defined. The female-structured fastener band 20 also comprises an elongated flexible band-like body, preferably made of plastics. The body of the female-structured fastener band 20 has an end, which is opposite to the ring 21 in the embodiment illustrated, forming a locking structure 23. The locking structure 23 forms a bore 231 extending therethrough. Mounted inside the bore 231 is a resilient plate 232, which forms a pawl 233.

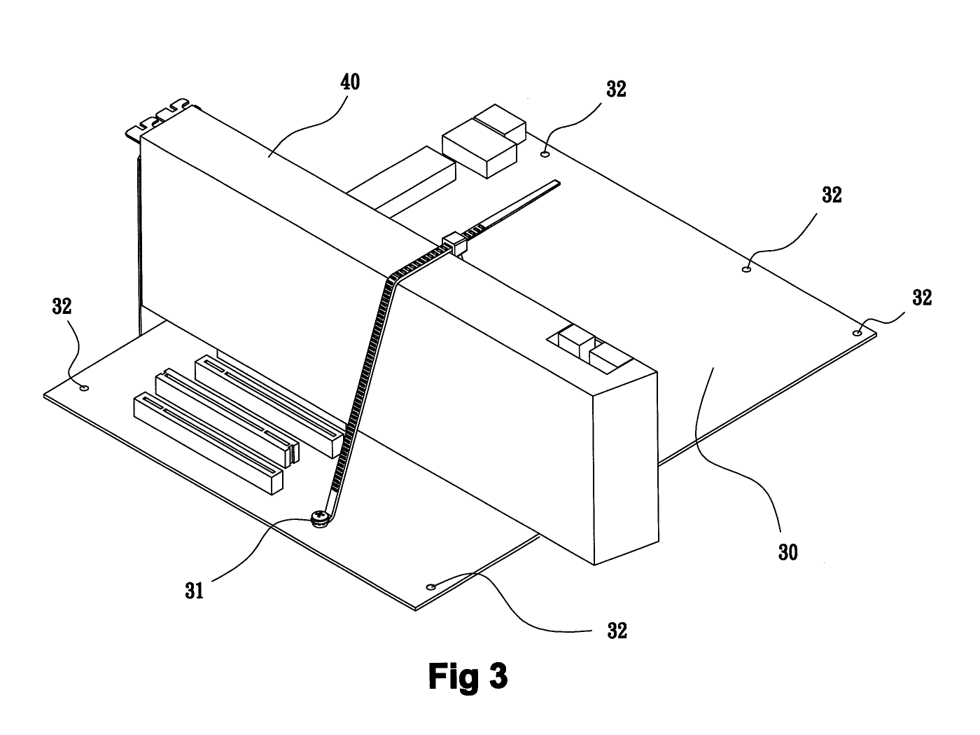

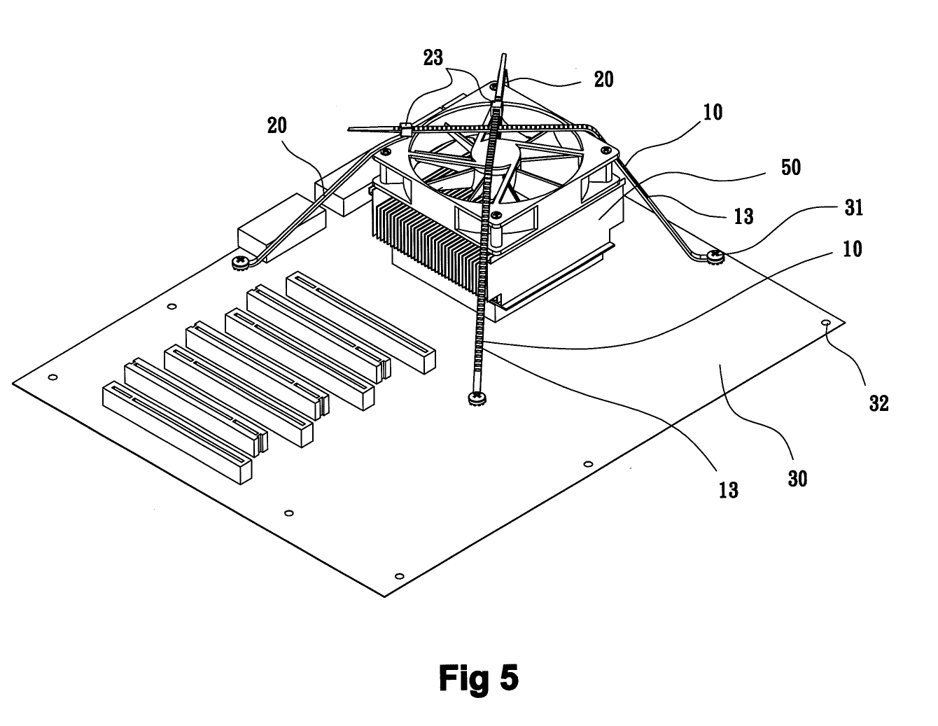

As such, the end holes 12, 22 of the fastener bands 10, 20 are positionable on a main board 30 (see FIG. 3) in alignment with holes formed in the main board 30. Bolts 31 that are applied to fix the main board 30 inside an enclosure may thus be also used to secure the fastener bands 10, 20 to the main board 30. A distal end of the male-structured fastener band 10 may then be inserted through the bore 231 of the locking structure 23 of the female-structured fastener band 20, whereby the pawl 233 of the locking structure 23 engages the serrated structure 13 and thus secure the male-structured fastener band 10 in position against reverse movement of the male-structured fastener band 10. The fastener bands 10, 20 thus hold an object, such as an interface card 40 (see FIG. 3) at a top of a central or end portion thereof, or hold a top of a heat sink 50 positioned on for example a central processing unit (CPU) (see FIG. 5). The fastener bands are then tightly stretched to securely fastener the interface card 40 or the heat sink 50 on the main board 30, whereby the interface card 40 or the heat sink 50 will not get off or separated from the main board 30 due to vibration or shocks caused by shipping or transportation of the electronic device containing the main board. The fastener bands have extremely simple structures but offer excellent effect of fastening so that the present invention is advantageous in terms of environmental conservation and energy saving.

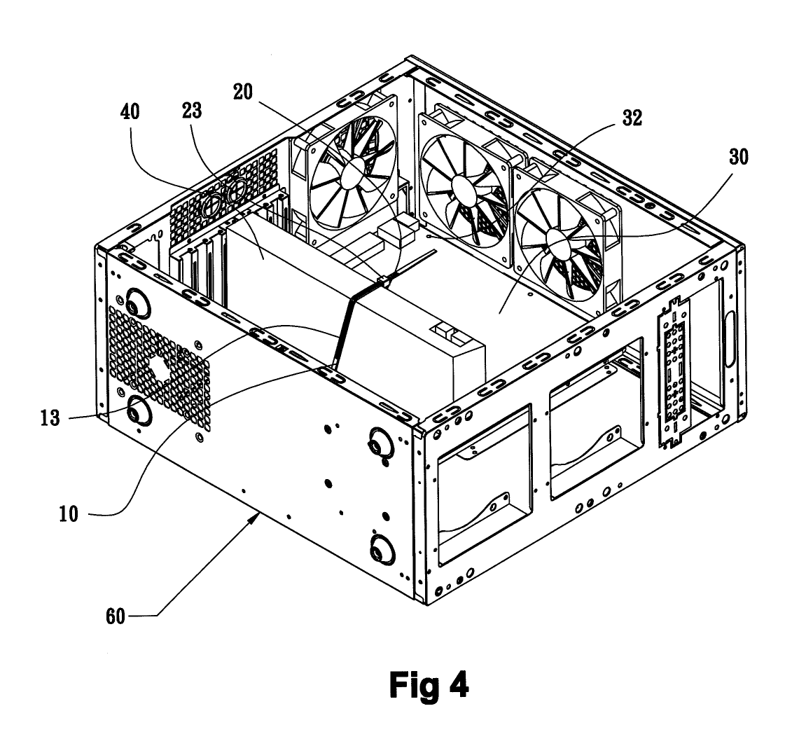

Referring to FIGS. 3 and 4, the main board 30 forms holes 32 at locations and sizes according to recognized standards, whereby the main board 30 is received in an enclosure 60 with the holes 32 set in alignment with corresponding holes defined in the enclosure 60. Bolts 31 are received through the holes to secure the main board 30 inside the enclosure 60. The main board 30 may carry thereon interface cards 40. To provide improved performance, the interface cards 40 are of a bulky structure and great weight, which can be as great as one or two kilograms. Since the positions of spots where an interface card 40 is secured to the main board 30 and the enclosure are pre-set, it is often hard to securely hold an interface card 40 that is heavy and bulky in position on the main board inside the enclosure. According to the present invention, by having the end holes 12, 22 of the male-structured fastener band 10 and the female-structured fastener band 20 aligning the holes 32 of the main board 30 to allow the bolts 31 to be received therethrough, the fastener bands 10, 20 can be secured in position at the time when the main board 30 is secured to the enclosure 60 by the bolts 31. With the flexible bodies of the male-structured fastener band 10 and the female-structured fastener band 20 set around a top of the interface card, the distal end of the male-structured fastener band 10 is put through the bore 231 of the female-structured fastener band 20 and the fastener bands are tightly stretched to imply a downward force acting on the interface card 40 to hold down and thus secure the interface card 40 in position on the main board.

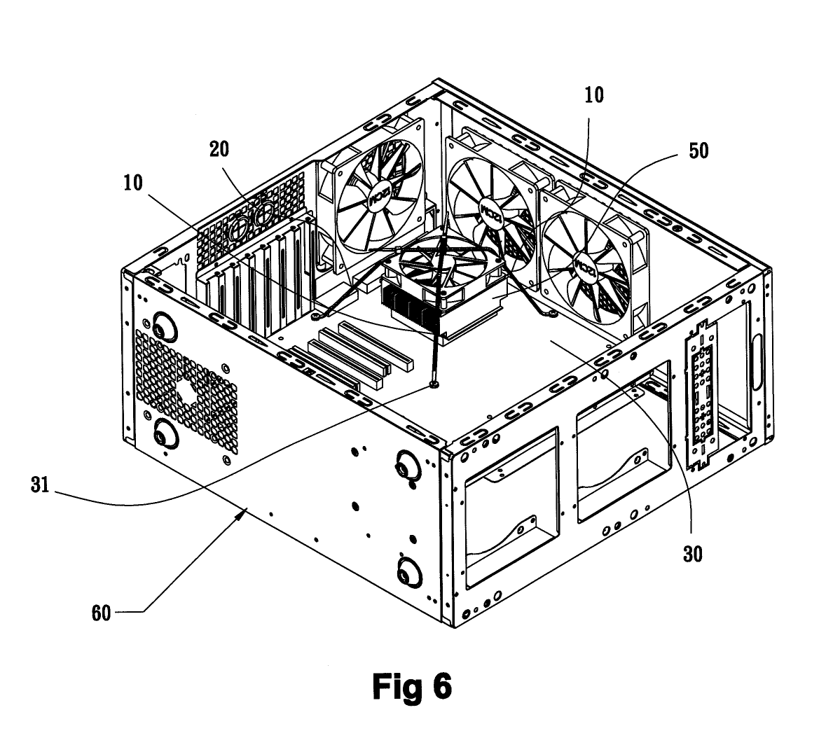

Referring to FIGS. 5 and 6, the main board 30 forms holes 32 at locations and sizes according to recognized standards, whereby the main board 30 is received in an enclosure 60 with the holes 32 set in alignment with corresponding holes defined in the enclosure 60. Bolts 31 are received through the holes to secure the main board 30 inside the enclosure 60. The main board 30 may carry thereon a CPU and a heat sink 50. To improve the performance, the CPU is now of high operation speed and thus generates an increased amount of heat and high temperature. To properly remove such an increased amount of heat, the heat sink 50 is enlarged in size and height and thus securely fastening is required to protect the heat sink from undesired damage and risk. According to the present invention, by having the end holes 12, 22 of the male-structured fastener band 10 and the female-structured fastener band 20 aligning the holes 32 of the main board 30 to allow the bolts 31 to be received therethrough, the fastener bands 10, 20 can be secured in position at the time when the main board 30 is secured to the enclosure 60 by the bolts 31. With the flexible bodies of the male-structured fastener band 10 and the female-structured fastener band 20 set around a top of the heat sink 50, the distal end of the male-structured fastener band 10 is put through the bore 231 of the female-structured fastener band 20 and the fastener bands are tightly stretched to imply a downward force acting on the heat sink 50 to hold down and thus secure the heat sink 50 in position on the main board.

To this point, it is apparent that the present invention offers the following advantages:

(1) The present invention provides a novel arrangement of fastener band assembly for fastening objects carried on a main board inside an enclosure by applying a hold-down force that securely holds the object, such as an interface card or a heat sink, on the main board, whereby excellent effect of fastening can be realized through the existing holes defined in the main board that receive bolts therein to secure the fastener bands to the main board and further, the fastener bands are extremely simple but offers excellent effect of fastening, making them advantageous in terms of environmental conservation and energy saving.

(2) The present invention provides a unique structure of fastener band assembly for use with a main board received in an enclosure, whereby by providing at least one set of the fastener band assembly, an object, such as an interface card can be securely held on the main board by a force induced by the fastener band assembly, or a heat sink can be securely held on the main body by the force induced by the fastener band assembly of the present invention, so that efficacies of simple structure, excellent result, environmental conservation, and energy saving can be realized.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A fastener band assembly adapted to securely fasten an object carried on a main board received in an enclosure, the fastener band assembly comprising:
a male-structured fastener band, which has an end forming a ring through which a hole is defined, the male-structured fastener band comprising an elongate flexible band-like body, which has a surface in which a serrated structure comprising a plurality of tooth-like portions is formed; and
a female-structured fastener band, which has an end forming a ring through which a hole is defined, the female-structured fastener band comprising an elongated flexible band-like body, which has an end forming a locking structure that forms a bore extending therethrough, a resilient plate being received in the bore and forming a pawl;
wherein the holes defined in the ends of the fastener bands are adapted to be positionable on the main board in alignment with holes formed in the main board to receive bolts that fix the main board therethrough for securing the fastener bands to the main board and wherein a distal end of the male-structured fastener band is insertable through the bore of the locking structure of the female-structured fastener band to allow the pawl of the locking structure to engage the serrated structure and thus secure the male-structured fastener band in position against undesired movement of the male-structured fastener band, whereby the fastener bands are extendable over a top of the object and the fastener bands are tightly stretchable to securely fastener the object.

2. The fastener band assembly as claimed in claim 1, wherein the object comprises an interface card.

3. The fastener band assembly as claimed in claim 1, wherein the object comprises a heat sink.
